(19) United States
(12) Patent Application Publication
(10) Pub. No.: US 2017/0230416 A1
(43) Pub. Date: Aug. 10, 2017

(54) System and methods for preventing phishing attack using dynamic identifier

(71) Applicant: Saranya Sabarish, Tampa, FL (US)

(72) Inventor: SARANYA SABARISH, TAMPA, FL (US)

(21) Appl. No.: 15/463,181

(22) Filed: Mar. 20, 2017

(51) Int. Cl. H04L 29/06

(52) U.S. Cl. CPC H04L 63/1483; H04L 63/0876

(57) ABSTRACT

The invention includes a method and apparatus for preventing phishing attacks. A first method, for informing a user that a remote server is valid, remote server sends the dynamic identifier to the system (client) and token app, then user validates and confirms whether the dynamic identifier matches between the system and the token app. The server receives, validates the confirmation and proceed with user authentication in the system. A second method, remote server and token app receives the dynamic identifier from the third party token provider. Remote server displays the dynamic identifier in the system. Token provider validates the entity of the remote server and displays that verified information in the token app along with dynamic identifier. Then user validates and confirms whether the dynamic identifier matches between the system and the token app. The token server receives, validates the confirmation and sends message to the entity server to proceed with user authentication in the system.

### CROSS-REFERENCE TO RELATED APPLICATIONS

This application claims the benefit of U.S. Provisional Application No. 62/310,845, filed Mar. 21, 2016, the disclosure of which is incorporated herein by reference.

### BACKGROUND OF THE INVENTION

As Internet usage increases, Internet-based crime is blooming. One prevalent crime is “phishing”, which is an attempt to trick an Internet user into providing personal information to the phishing attacker. The information typically sought by phishing attackers is Internet user login information (e.g., the login name and password for an Internet user) and, sometimes, other information such as credit card information, birth date, birth place, SSN, and the like. The phishing attackers use the obtained Internet user information in order to steal the identity of the Internet user. For example, a phishing attack may be used in order to obtain information to impersonate the Internet user (e.g., to log into e-mail accounts, to authorize credit card transactions, and to perform similar actions in the name of the Internet user).

Phishing attackers may use various different schemes to launch phishing attacks. A phishing attacker may use Domain Name Service (DNS) spoofing to direct users to a website owned by the attacker when users enter a Uniform Resource Locator (URL) of a real website. The spoofed website owned by the attacker is often a good look-alike; not exactly the same as the real website, but sufficiently convincing to not alert the user. Sometimes, the spoofed website may even connect to the real website in the back-end, acting as a pass-through to the real website. Furthermore, phishing attackers may register a domain name that closely resembles a well-known domain name (e.g., registering www.googel.com instead of www.google.com to attack users that mistype the real domain name).

In such schemes, where phishing attackers use DNS spoofing, the phishing attackers may wait until users enter the URL in an attempt to access the legitimate website or, alternatively, the phishing attackers may launch the attack by sending emails or instant messages to users that contain links to the spoofed website that is imitating the legitimate website. Where the phishing attacker launches the attack, the emails or instant messages appear to originate from the legitimate server of the legitimate website (e.g., by faking email addresses and using text and images similar to the those commonly used by the legitimate websites). Unfortunately, users are often duped into clicking on the links included in the phishing emails and instant messages.

Many attempts have been made to prevent phishing attacks. For example, attempts to prevent phishing attacks include using dedicated hardware solutions, one-time passwords, server-side certificates, graphical indications of security level (e.g., displaying an icon representing a padlock if the website displayed in the Internet browser is secure), client-side browser extensions (e.g., to check for typical signs of phishing, such as checking website URLs and checking the syntax of presented website pages), blacklists (e.g., maintaining lists of phishing webpages locally on a client or remotely on a server). Furthermore, static information or user personnel information is sometimes displayed to the user during login for use by the user in determining whether the website is legitimate. User personnel information verification is risk because phishing site might get some basic information from other websites and use it as legitimate information.

Disadvantageously, despite these attempts to prevent phishing attacks, users are still easily tricked by phishing attacks. For example, users often fail to check the validity of a website and, further, when they do check the users typically cannot tell the difference between a valid certificate and an invalid certificate. Some methods uses multi factor authentication, but the phishing site accepts any credential as valid credential and login to website and gets personal information. To avoid phishing attack of information, user can view and verify the identifier generates by the remote server or token provider and displayed in websites with the identifier displays in the token app. Therefore, there is clearly a need for an improved technique for preventing phishing attacks.

### BRIEF SUMMARY OF THE INVENTION

Various deficiencies in the prior art are addressed through the invention of a method and apparatus for preventing phishing attacks.

The invention includes a method and apparatus for preventing phishing attacks. A first method, for informing a user that a remote server is valid, includes receiving a dynamic identifier from the remote server to the system and token app, wherein the user validates and confirms whether the dynamic identifier matches between the system and the token app. The dynamic identifier may be onetime password (OTP), time based OTP, image, audio or any other dynamic identifier which send to both system and token app. The remote server may be a web server, an authentication server, or any other remote device with which the user may desire to authenticate or to verify. The system may be web site, app, kiosk, game console, or any other system through which user may login or verify remote server before sending information to remote server. The token app may be a mobile app, token device, or any other device or app with which user may verify the remote server's identifier with identifier shown in system.

A second method, remote server and token app receives the dynamic identifier from the third party token provider. Token provider may validates the authenticity of the entity who own the remote server and displays that entity verified information in the token app along with dynamic identifier. This gives more confident to the user about the remote server. Then user validates and confirms whether the dynamic identifier matches between the system and the token app.

### BRIEF DESCRIPTION OF THE DRAWINGS

FIG. 1. depicts a high-level block diagram of a system according to one embodiment of the present invention.

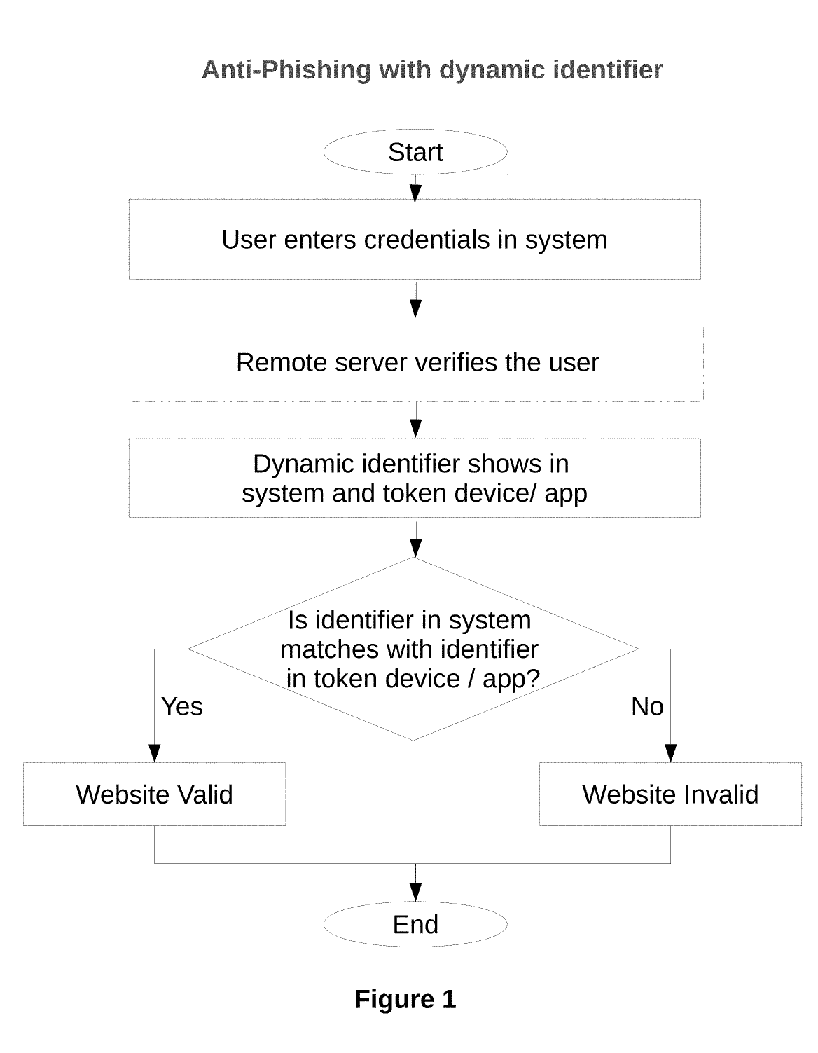

FIG. 2. depicts a method according to one embodiment of the present invention.

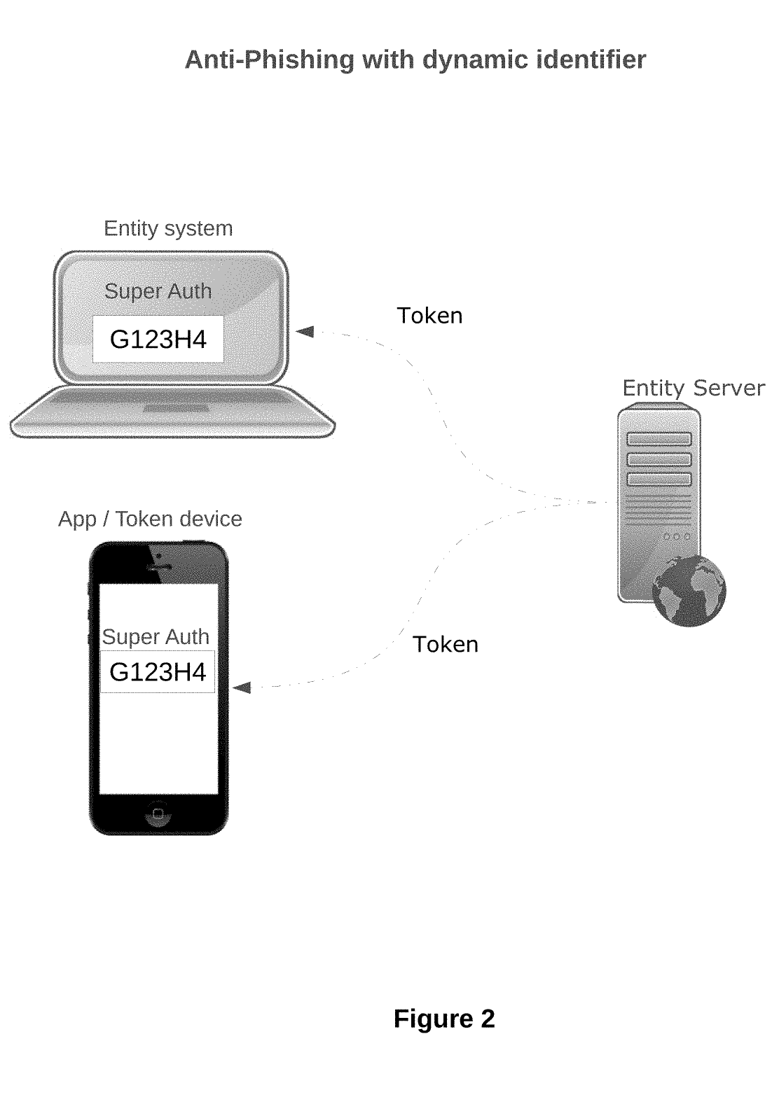

FIG. 3. depicts a method according to one embodiment of the present invention.

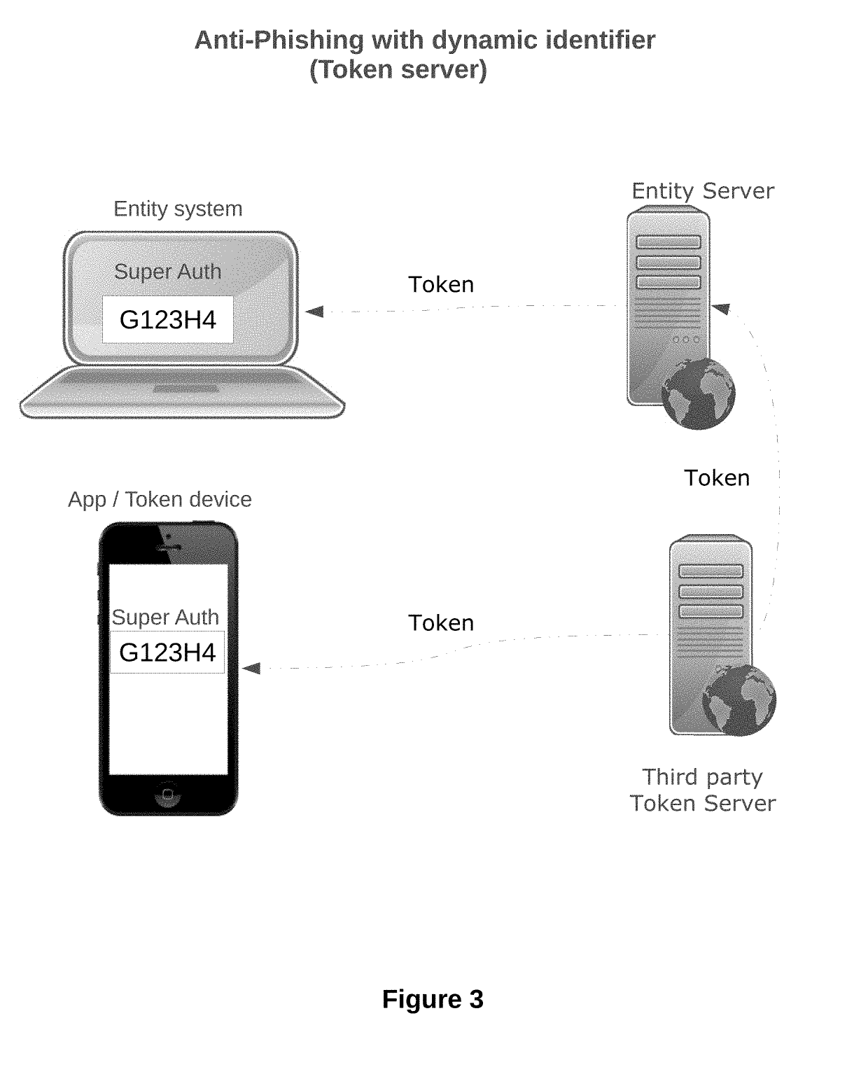

### DETAILED DESCRIPTION AND BEST MODE OF IMPLEMENTATION

The present invention enables a user to verify a dynamic identifier in a system with identifier in token device/app. The dynamic identifier of the user may be provided to the user during or after the authentication process (e.g. in response to a request from the user via a user terminal) or before the login process or whenever user likes to verify the system is legitimate. Since the dynamic identifier is provided to the user before the user enters sensitive data, the dynamic identifier may be used to distinguish valid servers from invalid servers (i.e., because the servers would not know the dynamic identifier) before the user enters any sensitive information.

The nature of the dynamic identifier displayed at the same time in system and token device provide a higher level of security for users than existing user authentication schemes in which static values or dynamic user attributes are used for server validation during user authentication. This is at least partly because the dynamic nature of the dynamic identifier display in both system and token device make it more difficult for a phishing attacker to obtain the dynamic identifier from token device and, furthermore, even if the phishing attacker does somehow obtain the dynamic identifier, the dynamic nature of the dynamic identifier ensures that the dynamic identifier will be quickly outdated.

The present invention is primarily depicted and described herein within the context of user authentication with a web server (e.g., for enabling the user to login to a website, app, kiosk, game console); however, as described herein, those skilled in the art will appreciate the present invention is not limited to user authentication with a web server. The present invention may be utilized to provide secure user authentication for various other user authentication applications, such as user authentication for financial transactions (e.g., ATM machines, debit card and credit card transactions, and the like), user authentication for network access, and the like. The present invention may be utilized whenever user is willing to check the credibility of the system (e.g., check before entering sensitive data such as SSN).

Entity, who owns or responsible for the web server, issues a token device or app to the user. In the token app, user gets the token from the entity server for the user. Entity stores the token info for that user in server. Once user sign in entity system, entity system shows the token on screen. The same token also displays in the user token device or mobile app. User verifies and confirms whether the token on the entity screen and the token device or mobile app is on synch. If token matches, user understand that s/he is using valid entity system and if not, then the system might be phishing system. The confirmation message sends to the server. The server validates and proceed with the user authentication or verification.

If entity uses third party token provider (a.k.a. provider), then there are different ways of communicating tokens between entity system and user. In one method, once user signed in to entity system, user get the token information from token provider and input the token info into entity system. Entity system stores the information in server. Sometime, entity system can get the token info for the signed user directly from the provider and avoid user inputting that info. User also gets token device or app from token provider or store the token info in provider's app. After that, when user verifies the entity system, entity's server generates the token based on user's token info and provider's algorithm or entity's server gets the token from provider and displays in the screen. User compares and verifies the token shows between token device and entity system. The confirmation message sends to the token server. The token server validates and send message to entity server to proceed with the user authentication or verification.

In another method, User signed in to token provider app and verifies the identity such as via email or phone verification. When user signed in entity system, entity system provides user identity such as email or phone and gets the corresponding token to display on the screen. Provider also sends the token to the user's provider app. Now, user can verifies the token between entity system and app token. User can also directly gets the token via email or phone text or call.

In provider method, provider validates the entity information such as organization or personal information. When sending token to token device or app, provider also specifies the verified entity information. Sometimes, provider also send entity system landing domain or app. This gives the user more confident about the entity system.

What is claimed is:

1. A system to implement view and confirm dynamic identifier, the system comprising:
a remote or entity server, the server being operable to execute a server authentication algorithm stored on the server, the server authentication algorithm implementing an authentication protocol on the server, the authentication protocol implementing generate and display the dynamic identifier (token) in the entity system and in token device or app and accept the confirmation message from token device and/or client;
an entity system, a client, in communication with the server, the client being operable to execute a client authentication algorithm, the client authentication algorithm implementing the authentication protocol on the client, the client comprising a browser or app operable to permit a user to access the application on the server and display the dynamic identifier (token) that sent by the server and may be send the confirmation message to server;
a token device, the device being operable to execute a device authentication algorithm stored on the device, the device authentication algorithm implementing the authentication protocol on the device. Token device display the dynamic identifier (token) that sent by the server and may be send the confirmation message to server;
the device authentication algorithm being operable to display the dynamic identifier that sent by the server or generate and display a dynamic identifier and send the confirmation message to the server when user verifies and confirm whether the dynamic identifier matches between system (client) and the token device;
the client authentication algorithm being operable to display the dynamic identifier that sent by the server and send the confirmation message to the server when user verifies and confirm whether the dynamic identifier matches between system (client) and the token device; and
the server authentication algorithm being operable to receive the confirmation message from then token device or client and decide to authenticate a user or proceed with the user to the application.
the optional third party token provider reduce the workload of entity to generate token in the entity server and maintain token device. Token server generates the dynamic identifier and sends to entity server and token device. Entity server displays the token in the entity system (client). Once user verifies and confirms the dynamic identifier to the token server, token server sends the confirmation message to entity server to authenticate the user.

2. The system of claim 1 wherein the client authentication algorithm is stored on the client as one of:
a plug-in application for the browser; a web page provided to the client by the application on the server;
a login screen;
a programs, app, kiosk, game console, application or any other system through which user login or verify the remote server.

3. The method of claim 1 wherein the server authentication algorithm is operable to generate a dynamic identifier (token) and provide the dynamic identifier (token) to the system (client) and token device. The server authentication algorithm is operable to accept the confirmation message from token device or client and accept the login.

4. The system of claim 3 wherein:
the client authentication algorithm is operable to display the dynamic identifier on the entity system (client); and
the client may receive multiple dynamic identifier to display and user selects which identifier matches with the identifier display in the token device.

5. The system of claim 3 wherein:
the device authentication algorithm is operable to display the same dynamic identifier on the token device; and
the token device may receive multiple dynamic identifier to display and user selects which identifier matches with the identifier display in the client.

6. The system of claim 1 wherein the dynamic identifier as one of: group of letters, number or special characters, onetime password (OTP), time based OTP, image, audio or any other dynamic identifier.

7. The system of claim 5 wherein:
the user confirms the matching dynamic identifier on token device and device authentication algorithm send that confirmation to the server;
the user confirms the matching dynamic identifier on the client and client authentication algorithm send that confirmation to the server;
the server may get the confirmation message from token device or from client or from both token device or client.

8. The system of claim 1 wherein: all communications between token device, server, and clients using wired or wireless connections.

9. The system of claim 1 further comprises:
the input to the device authentication algorithm is the user launching the device authentication algorithm on the device;
the device authentication algorithm is operable to display the dynamic identifier on the device; and
the server authentication algorithm is operable to receive the confirm message by the user viewing the device.

10. The system of claim 9 wherein:
the server authentication algorithm generates the dynamic identifier and sends the identifier to token device and the client;
the device authentication algorithm displays the identifier and send the confirmation message to the server; and
the server authentication algorithm is operable to decide to authenticate a user to the application using the response message.

11. A dynamic identifier view and confirm authentication method comprising:
generating a dynamic identifier at a server in response to a user accessing a web page or application on the server with a web browser or program on a client;
sending the dynamic identifier to the client and the token device;
displaying, by the token device, user confirms the dynamic identifier;
transferring the confirmation message from the device to the server;
evaluating, by the server, the confirmation message to authenticate the user to the web page or application.

12. The method of claim 11 further comprises completing an initialization phase prior to generate a dynamic identifier.

13. The method of claim 12 wherein said completing an initialization phase includes:
selecting an authentication protocol;
storing user information to be used by the selected authentication protocol;
transferring set-up information relating to the selected authenticated protocol to the client and token device; and
storing the transferred set-up information on the client and token device. Prior authentication or verification of user between client and server. Prior authentication or verification of user between token device and server.

14. The method of claim 11 wherein said evaluating the confirmation message includes: calculating a hash value with the confirmation message;
comparing the calculated hash value to a stored hash value; and
authenticating the user in response to the calculated hash value matching the stored hash value.

15. The method of claim 11 wherein said generating a dynamic identifier includes encrypting the dynamic identifier using public key encryption.

16. The system of claim 1 wherein the token provider server follows similar protocol, claims and algorithm of the entity server.

17. The system of claim 1 wherein the token provider token device displays the entity information along with the dynamic identifier.
